(19) United States
(12) Patent Application Publication
(10) Pub. No.: US 2019/0044816 A1
(43) Pub. Date: Feb. 7, 2019

(54) FILTERING RESPONSES TO DISCOVERY REQUESTS

(71) Applicant: HEWLETT PACKARD ENTERPRISE DEVELOPMENT LP, Houston, TX (US)

(72) Inventor: Rajesh Narayanan, Palo Alto, CA (US)

(21) Appl. No.: 15/669,456

(22) Filed: Aug. 4, 2017

(51) Int. Cl. H04L 12/24; H04L 29/12

(52) U.S. Cl. CPC H04L 41/12; H04L 61/2076

(57) ABSTRACT

In some examples, a system receives a discovery request, sent by a requester device, that is multicast to a plurality of access servers that control access to network services. The system applies filtering of a response to the discovery request from a given access server of the plurality of access servers, such that the filtering of the response determines whether the response from the given access server is returned to the requester device.

### BACKGROUND

A customer premise equipment (CPE) can refer to any endpoint device that can be used by a user or a program to access services provided by a service provider system. Examples of endpoint devices can include desktop computers, notebook computers, tablet computers, smartphones, telephones, appliances, and so forth. The services can be accessed by the endpoint devices through access servers.

### BRIEF DESCRIPTION OF THE DRAWINGS

Some implementations of the present disclosure are described with respect to the following figures.

FIG. 1 is a block diagram of an arrangement that includes requester devices, a switch fabric, and access servers, according to some examples.

FIGS. 2-4 are block diagrams of respective arrangements that show deployment of an access server response filter deployed at different locations, according to various examples.

FIG. 5 is a block diagram of another arrangement that includes requester devices, a switch fabric, control plane servers, and data plane servers, according to further examples.

FIG. 6 is a block diagram of a storage medium storing machine-readable instructions according to further examples.

FIG. 7 is a block diagram of a system according to other examples.

FIG. 8 is a flow diagram of a process according to additional examples.

FIG. 9 block diagram of a different arrangement that includes requester devices, a switch fabric, a control plane server, and data plane servers, according to alternative examples.

FIG. 10 is a flow diagram of a process performed by the arrangement of FIG. 9, according to alternative examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a service provider system can include access servers that can be used by endpoint devices to access respective services provided by the service provider system. A “service provider system” can refer to an arrangement of machines and programs (including machine-readable instructions such as software and firmware) that provide services that are accessible by endpoint devices. The service provider system can be managed or owned by a service provider, which can be an organization or other entity.

An “access server” can refer to a machine or program that manages or controls access to a respective service of the service provider system. For example, an access server can include a Broadband Remote Access Server (BRAS), which is also referred to as a Broadband Network Gateway (BNG). A BRAS or BNG is an access point for an endpoint device, through which the endpoint device can connect to a broadband network. A broadband network can refer to a network that has communication speeds that are greater than a specified threshold.

A BRAS or BNG provides an endpoint device with a network access service to allow the endpoint device to communicate data over a network. Examples of tasks that can be performed by a BRAS or BNG can include subscriber session management, network address (e.g., Internet Protocol or IP address) assignment, policy enforcement, quality-of-service (QoS) management, and so forth.

A BRAS or BNG can refer to a physical entity or to a virtual entity. A virtual BRAS or virtual BNG can be deployed in a physical system. In some examples, multiple virtual BRAS or BNG instances can be deployed in a physical system.

In other examples, access servers can include web servers, which can provide endpoint devices with access to web resources. In further examples, access servers can provide endpoint devices with access to other types of remote services.

In an environment with multiple access servers, load balancing may be performed to prevent any one access server from becoming overloaded while another access server is lightly loaded. If a large number of endpoint devices access a first access server while a small number of endpoint devices access a second access server, then a load imbalance condition results in which the first access server is overloaded (and thus can run at a lower speed or efficiency) while the second access server is underutilized. In some examples, a load balancer can be deployed to balance requests of endpoint devices across the multiple access servers. However, such a load balancer may be costly to deploy since the load balancer has to be configured with detailed information regarding the access servers, which can make scalability difficult since any addition of an access server may lead to a re-configuration of the load balancer. In addition, some load balancers have to handle traffic data packets at line rate (the rate at which data is communicated in a network) while making decisions regarding which target access server or other network element to send the traffic data packets to.

In accordance with some implementations of the present disclosure, to perform implicit load balancing where an actual load balancer is not used, techniques or mechanisms can apply filtering of responses to discovery requests multicast by a requester device (such as an endpoint device) to multiple access servers. The filtering of a response determines whether the response from a respective access server is returned to the requester device. As used here, the “filtering of a response” refers to the act of deciding whether or not the response is to be returned to the requester device, in response to a discovery request sent by the requester device.

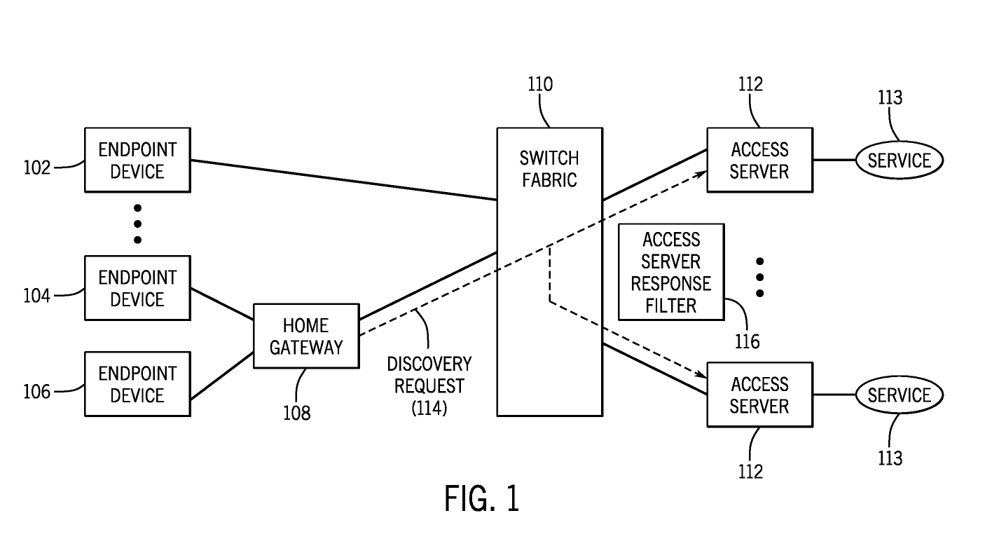

FIG. 1 illustrates an example arrangement that includes various endpoint devices 102, 104, and 106. The endpoint devices 104 and 106 are connected to a home gateway 108, which is in turn connected to a switch fabric 110. The switch fabric 110 interconnects the endpoint device 102 and the home gateway 108 to access servers 112. The endpoint devices 102, 104, and 106 are able access services 113 provided by the access servers 112. The access servers 112 control access to the services 113.

As used here, a “switch fabric” can refer to an arrangement of a switch or of multiple switches, where a switch refers to a network node that is used to route or forward data from a first network entity to another network entity. The endpoint device 102 can be directly connected to the switch fabric 110 without passing through a home gateway. In some examples, communication in a network that includes the switch fabric 110 is according to a specific protocol. The endpoint device 102 supports this specific protocol, and thus is able to be directly connected to the switch fabric 110. On the other hand, the endpoint devices 104 and 106 may not be configured to support the specific protocol. The endpoint devices 104 and 106 are connected to the home gateway 108 that is configured to support the specific protocol.

In some examples, the specific protocol used for communications in the network that includes the switch fabric 110 is a Point-to-Point Protocol over Ethernet (PPPoE) protocol. PPPoE is a network protocol for encapsulating PPP frames inside Ethernet frames, where a “frame” refers to a unit of data. PPP is a data link protocol used to establish a direct connection between two network entities.

In other examples, communications in the network including the switch fabric 110 can be according to other protocols. An example of another protocol can be a Dynamic Host Configuration Protocol (DHCP). DHCP is a network protocol used in Internet Protocol (IP) networks for dynamically distributing network configuration parameters from a DHCP server to endpoint devices.

In further examples, other protocols can be used for communications between network entities through the switch fabric 110.

In some examples, a protocol used for communications between network entities through the switch fabric 110 provides for a discovery procedure in which a requester device sends a discovery request to obtain certain information that is to be used by the requester device for communications in the network. For example, if the PPPoE protocol is used, a PPPoE discovery request can be issued by a requester device to discover the network address (such as a Medium Access Control or MAC address) of a target device, such that the requester device can communicate with the discovered network address to communicate with the target device. In some examples, the target device can include one of the access servers 112, or alternatively, multiple access servers.

The requester device can be either the endpoint device 102, or the home gateway 108 in the example of FIG. 1. In further examples, other devices can be requester devices. The requester device sends a PPPoE discovery request to the access servers 112 through the switch fabric 112. The access servers 112 respond to the discovery request with specified information, including MAC addresses of the access servers 112. The requester device can use the MAC address of an access server 112 to communicate with the access server 112.

In examples where DHCP is used, a DHCP discovery request can be issued by a requester device (e.g., endpoint device 102 or home gateway 108) to discover a network address (e.g., an IP address) and other configuration parameters of the requester device. The discovered IP address and other configuration parameters can be used by the requester device to communicate with an access server 112.

In some examples, a discovery request sent by a requester device can be multicast by the switch fabric 110 to multiple access servers 112. Multicasting a request can refer to sending the request to more than one target device. The term “multicast” can refer to sending of a request to multiple target devices within a group, or can refer to broadcasting the request to target devices connected to a network.

In the example of FIG. 1, it is assumed that the home gateway 108 is the requester device that has sent a discovery request 114 to the switch fabric 110, which multicasts the discovery request 114 to the access servers 112. In response to the discovery request 114, each access server 112 would normally send a response to the discovery request back to the requester device, which in the example of FIG. 1 is the home gateway 108. However, if all access servers 112 respond to discovery requests from requester devices, then there is a chance that requester devices can access the services provided by a first subset of access servers 112 more than a second subset of access servers 112. As a result, the first subset of access servers can become overloaded.

In accordance with some implementations of the present disclosure, an access server response filter 116 is provided to apply filtering of a response to the discovery request 114 by a given access server 112, where the filtering of the response applied by the access server response filter 116 determines whether or not a response to the discovery request 114 is returned by the given access server 112 to the requester device (home gateway 108 in the example of FIG. 1).

The filtering applied by the access server response filter 116 can be based on a criterion. For example, the criterion can include any or some combination of the following: a time criterion (e.g., a response from a specific access server 112 is returned in response to a discovery request in a specified time range), a location criterion (e.g., a response from an access server 112 within a specified proximity is returned in response to a discovery request), or any other criterion.

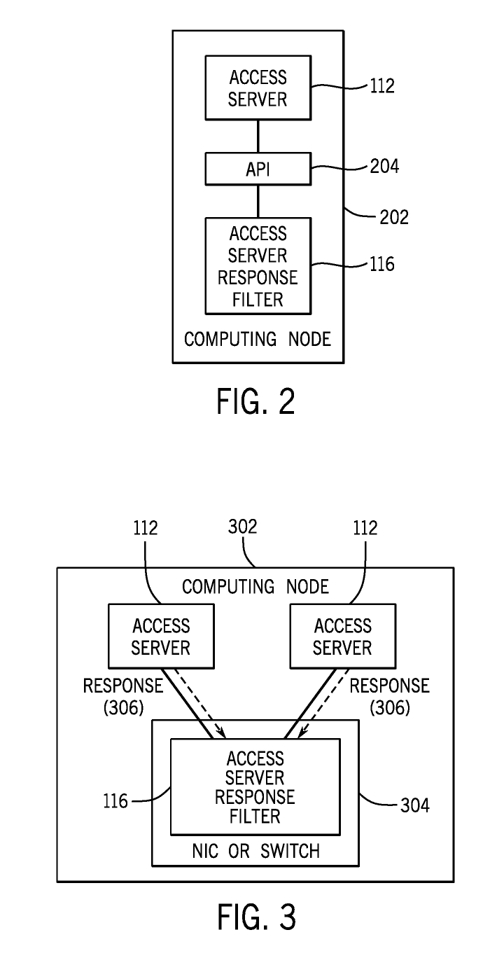

The access server response filter 116 can be deployed at any of various locations in the network. For example, as shown in FIG. 2, the access server response filter 116 can be a program that is executed on a computing node 202 that also includes a respective access server 112. The respective access server 112 can interact with the access server response filter 116 to determine whether or not a response to the discovery request 114 is to be sent to the requester device. In some examples, an application programming interface (API) 204 can be provided that allows for interaction between the access server 112 and the access server response filter 116. The API 204 includes routines that can be invoked by the access server 112 to interact with the access server response filter 116. In other examples, other types of interfaces can be provided between the access server 112 and the access server response filter 116.

With the FIG. 2 implementations, there can be multiple computing nodes 202 each with a respective access server 112 and access server response filter 116.

FIG. 3 shows another example arrangement, in which a computing node 302 includes multiple access servers 112, which can be virtual access servers. The access server response filter 116 can be part of another entity 304 in the computing node 302. The entity 304 can include a network interface controller (NIC) or a switch, and the access server response filter 116 can execute in the NIC or switch. In some examples, the NIC or switch can be a virtual NIC or a virtual switch deployed in the computing node 302.

The access server response filter 116 in the entity 304 can receive responses 306 to the discovery request 114 from each of the access servers 112 in the computing mode 302, and the access server response filter 116 can apply a filtering to select one (or none) of the responses from one of the access servers 112 to pass back to the requester device in response to the discovery request. In further examples, the filtering applied by the access server response filter 116 can cause more than one response to the discovery request 114 to be passed to the requester device.

In some examples, there may be multiple computing nodes 302 each with multiple access servers 112 and a corresponding access server response filter 116.

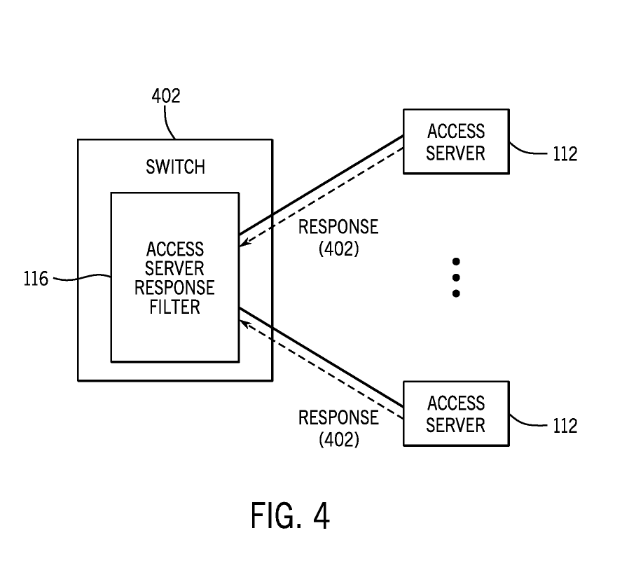

FIG. 4 shows another example arrangement that includes a switch 402, which can be part of the switch fabric 110 of FIG. 1. The switch 402 includes the access server response filter 116. The access server response filter 116 receives responses 402 to the discovery request 114 from the respective access servers 112. The access server response filter 116 applies filtering to select one (or more than one) of the responses 402 to forward to the requester device in response to the discovery request 114.

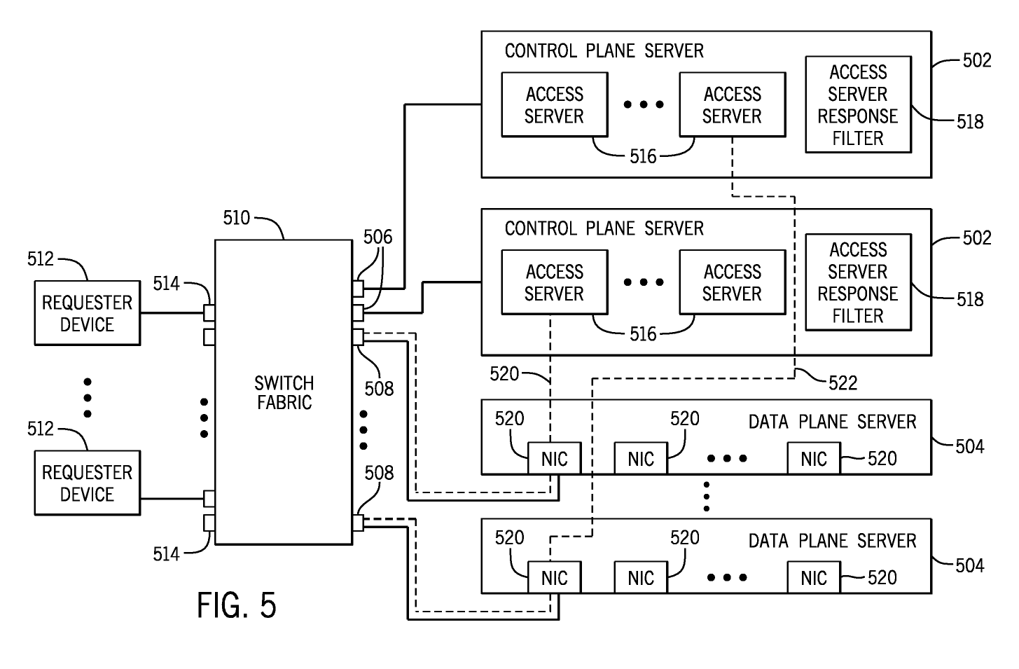

FIG. 5 illustrates an example arrangement according to further examples. In FIG. 5, multiple control plane servers 502 and multiple data plane servers 504 are connected to ports 506 and 508, respectively, of a switch fabric 510. The switch fabric 510 can include a switch or multiple switches. As further shown in FIG. 5, requester devices 512 are connected to respective ports 514 of the switch fabric 510.

FIG. 5 shows an example where a control plane and a data plane are separated across different servers. The data plane, implemented with the data plane servers 504, is used to perform communication of data relating to access of a service by a requester device 512.

The control plane, implemented with the control plane servers 502, is used to perform various control tasks with respect to sessions established by a requester device 512 when accessing a service. As noted above, such control tasks can include subscriber session management, network address assignment, policy enforcement, QoS management, and so forth. More specifically, the control tasks of the control plane are performed by access servers 516 in the control plane servers 502.

Each control plane server 502 further includes a respective access server response filter 518, for applying filtering of responses of access servers 516 to discovery requests from a requester device 512. Although FIG. 5 shows the access server response filters 518 being provided as part of respective control plane servers 502, the access server response filters 518 can be provided at other locations in other examples, such as in the switch fabric 510.

Each data plane server can include multiple NICs 520 that perform data communications with the requester devices 512 through the switch fabric 510. In some examples, each data plane server 504 can include data processing logic, such as logic to perform encoding or decoding of data, compression or decompression of data, and so forth.

In some examples, the switch fabric 510 can learn the network addresses (e.g., MAC addresses) of the access servers 516. The switch fabric 510 includes routing information (e.g., a routing table) that contains entries used for routing data between requester devices and services controlled by the control plane servers 502. A routing table entry can map network addresses (e.g., IP addresses or MAC addresses) in a packet to a port of the switch fabric 510 through which the packet is to be routed. Learning a network address of an access server 516 allows the switch fabric 510 to populate the routing table of the switch fabric 510 so that packets can be properly routed.

In some examples, the switch fabric 510 does not learn the network addresses on the ports 506 of the switch fabric 510 that are connected to the control plane servers 502. Instead, the switch fabric 510 learns the network addresses of the access servers 516 on the ports 508 connected to the data plane servers 504.

In some examples, an access server 516 can establish a virtual path through a data plane server 504 to a corresponding port 508 of the switch fabric 510. For example, as shown in FIG. 5, one of the access servers 516 has established a virtual path 520 through a data plane server 504 with a corresponding port 508. Another access server 516 has established a virtual path 522 through another data plane server 504 through another corresponding port 508.

In some examples, a virtual path can be preconfigured, such as by an administrator. In other examples, a virtual path can be configured in a different manner. A purpose of the virtual path is to provide a layer 2 (L2) network between the virtual interface of the access server and the physical interface on which the data plane port is connected to the switch.

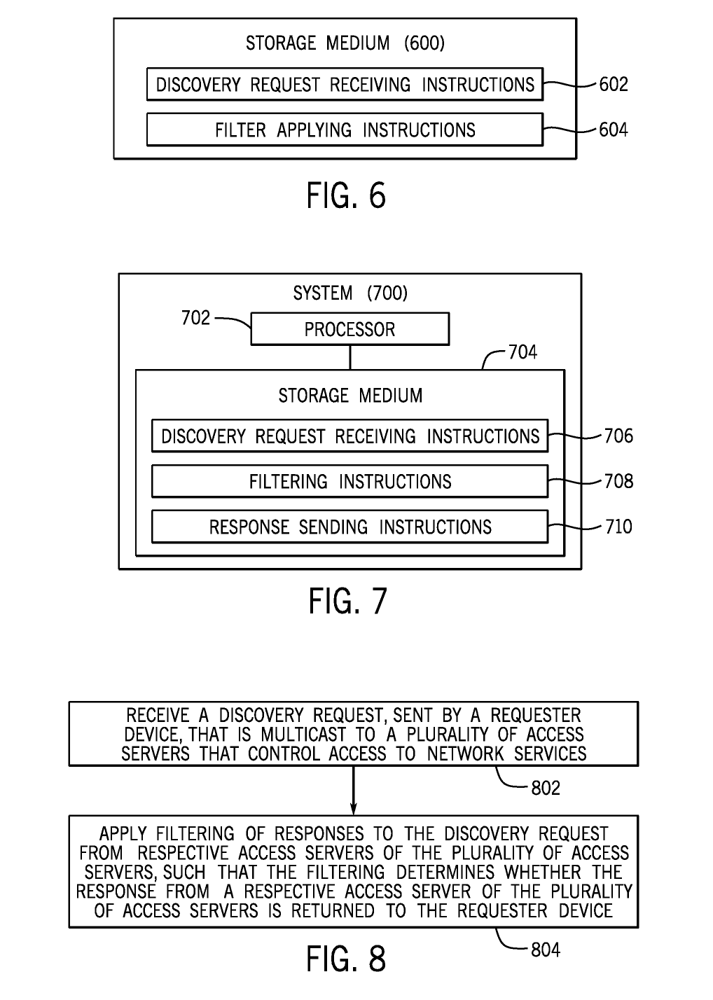

FIG. 6 is a block diagram of a non-transitory machine-readable or computer-readable storage medium 600 storing machine-readable instructions according to further implementations. The machine-readable instructions upon execution by a system cause the system to perform various tasks.

The machine-readable instructions include discovery request receiving instructions 602 to receive a discovery request, sent by a requester device, that is multicast to a plurality of access servers that control access to network services. The machine-readable instructions further include filtering applying instructions 604 to apply filtering of a response to the discovery request from a given access server of the plurality of access servers, such that the filtering of the response determines whether the response from the given access server is returned to the requester device.

FIG. 7 is a block diagram of a system 700 according to further examples. The system 700 includes a processor 702 and a storage medium 704 storing machine-readable instructions executable on the processor 702 to perform various tasks. Machine-readable instructions executable on a processor can refer to the machine-readable instructions executable on a single processor or on multiple processors. A processor can include a microprocessor, a core of a multi-core microprocessor, a microcontroller, a programmable integrated circuit, a programmable gate array, or another hardware processing circuit.

The machine-readable instructions include discovery request receiving instructions 706 to receive a discovery request, sent by a requester device, that is multicast to a plurality of access servers that control access to network services. The machine-readable instructions further including filtering instructions 708 to apply filtering of a response to the discovery request from a given access server of the plurality of access servers, such that the filtering of the response determines whether the response from the given access server is returned to the requester device. The machine-readable instructions further include response sending instructions 710 to, based on the filtering indicating that the response is to be returned to the requester device, send the response to the requester device.

FIG. 8 is a flow diagram of a process according to additional examples. The process of FIG. 8 receives (at 802) a discovery request, sent by a requester device, that is multicast to a plurality of access servers that control access to network services. The process further applies (at 804) filtering of responses to the discovery request from respective access servers of the plurality of access servers, such that the filtering determines whether the response from a respective access server of the plurality of access servers is returned to the requester device.

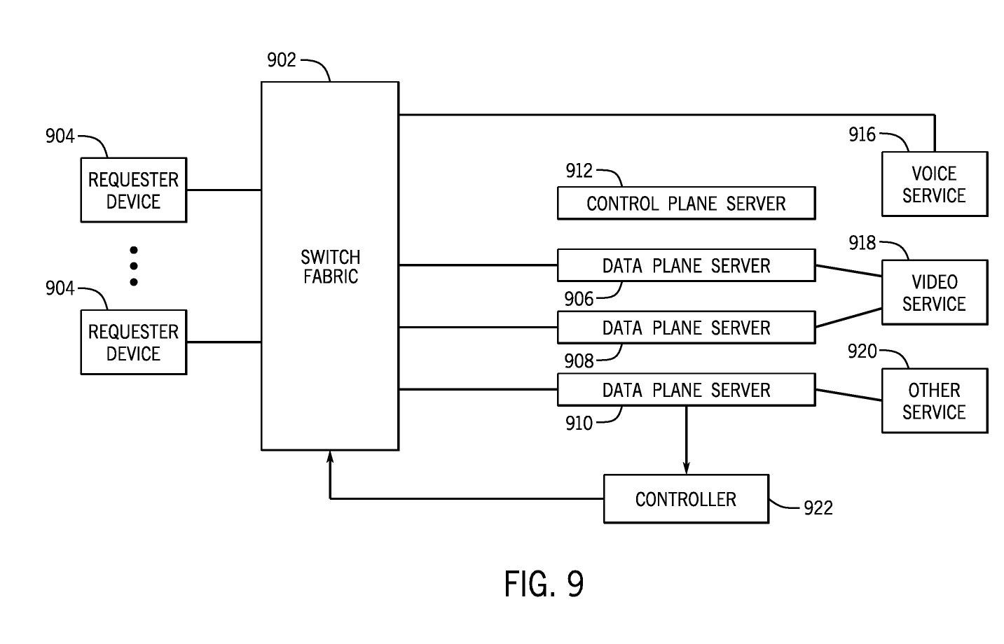

FIG. 9 is a block diagram of an arrangement in which data flows of respective different types are provided through respective data plane servers to corresponding services. In FIG. 9, a switch fabric 902 connects requester devices 904 to corresponding data plane servers 906, 908, and 910. A control plane server 912 is also depicted in FIG. 9, where the control plane server 912 can include various access servers as discussed above.

The different data plane servers 906, 908, and 910 can be dedicated for use for different types of data. For example, the data plane servers 906 and 908 can be used for forwarding and processing video data of a video service 918. In some examples, the data plane servers 906 and 908 can include video encoders or decoders to perform video encoding or decoding of video data transmitted to or from the video service 918.

As further shown in FIG. 9, the data plane server 910 can be used to forward and process data of another service 920.

In FIG. 8, voice data to or from a voice service 916 can be routed through the switch fabric 802 without passing through a data plane server.

Each data plane server 906, 908, and 910 can perform deep packet inspection of data communicated with a requester device 904. Based on the deep packet inspection, a classification of the data can be performed, to indicate the type of data (e.g., voice data, video data, or other data) communicated with the requester device 904. The classification of the data can be provided to a controller 922, which can then use the classification of the data to program routing information in the switch fabric 902 to cause data communicated with the requester device 904 (or within a session of the requester device 904) to be routed to a selected data plane server or to bypass the data plane servers 906, 908, and 910.

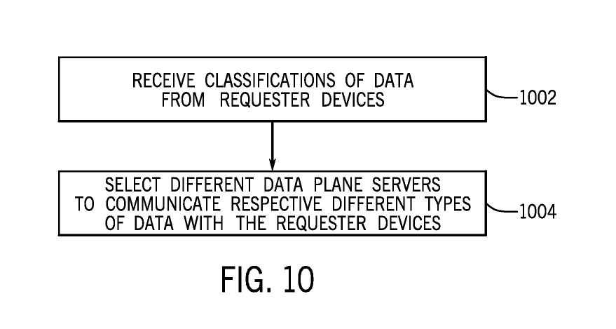

FIG. 10 is a flow diagram of a process that can be performed with the arrangement of FIG. 9, according to some examples. In some examples, the process of FIG. 10 can be performed by the controller 922. The process of FIG. 10 includes receiving (at 1002) classifications of data from requester devices. The process of FIG. 10 further incudes selecting (at 1004) different data plane servers to communicate respective different types of data with the requester devices, the different types of data identified by the classifications.

The storage medium 600 (FIG. 6) or 704 (FIG. 7) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a system to:
receive a discovery request, sent by a requester device, that is multicast to a plurality of access servers that control access to network services; and
apply filtering of a response to the discovery request from a given access server of the plurality of access servers, such that the filtering of the response determines whether the response from the given access server is returned to the requester device.

2. The non-transitory machine-readable storage medium of claim 1, wherein the plurality of access servers comprise virtual access servers.

3. The non-transitory machine-readable storage medium of claim 1, wherein the discovery request comprises a Point-to-Point Protocol over Ethernet (PPPoE) discovery request.

4. The non-transitory machine-readable storage medium of claim 1, wherein the discovery request comprises a Dynamic Host Configuration Protocol (DHCP) discovery request.

5. The non-transitory machine-readable storage medium of claim 1, wherein the filtering is applied at a computing node including the given access server.

6. The non-transitory machine-readable storage medium of claim 1, wherein the filtering is applied at a switch in a network between the plurality of access servers and the requesting device.

7. The non-transitory machine-readable storage medium of claim 1, wherein the filtering is applied at a virtual entity in a node.

8. The non-transitory machine-readable storage medium of claim 1, wherein the filtering is based on a criterion.

9. The non-transitory machine-readable storage medium of claim 1, wherein the filtering causes a response from only one of the plurality of access servers to be received by the requester device.

10. The non-transitory machine-readable storage medium of claim 1, wherein the plurality of access servers comprise broadband network gateways.

11. The non-transitory machine-readable storage medium of claim 1, wherein the plurality of access servers comprise web servers.

12. The non-transitory machine-readable storage medium of claim 1, wherein the response to the discovery request from the given access server comprises a network address of the given access server or a network address of the requestor device.

13. A system comprising:
a processor; and
a non-transitory storage medium storing instructions executable on the processor to:
receive a discovery request, sent by a requester device, that is multicast to a plurality of access servers that control access to network services;
apply filtering of a response to the discovery request from a given access server of the plurality of access servers, such that the filtering of the response determines whether the response from the given access server is returned to the requester device; and
based on the filtering indicating that the response is to be returned to the requester device, send the response to the requester device.

14. The system of claim 13, comprising a computing node including the processor, the non-transitory storage medium, and the given access server.

15. The system of claim 13, wherein the instructions are part of a virtual network interface controller or a virtual switch.

16. The system of claim 13, wherein the sending of the response to the requester device is through a switch fabric.

17. The system of claim 13, comprising a switch including the processor and the non-transitory storage medium, wherein the switch is to learn a network address of the given access server based on the response passing through the switch to the requester device.

18. The system of claim 17, wherein the switch includes first ports connected to nodes including the plurality of access servers, and second ports connected to data plane servers, and wherein the switch is to receive the response in a virtual path defined through one of the second ports.

19. A method comprising:
receiving, by a system comprising a processor, a discovery request, sent by a requester device, that is multicast to a plurality of access servers that control access to network services; and
applying, by the system, filtering of responses to the discovery request from respective access servers of the plurality of access servers, such that the filtering determines whether the response from a respective access server of the plurality of access servers is returned to the requester device.

20. The method of claim 19, further comprising:
performing implicit load balancing across the plurality of access servers using the filtering.

21. A method of a system comprising a processor, comprising:
receiving classifications of data from requester devices; and
selecting different data plane servers to communicate respective different types of data with the requester devices, the different types of data identified by the classifications.
